(19) United States
(12) Patent Application Publication
(10) Pub. No.: US 2025/0104345 A1
(43) Pub. Date: Mar. 27, 2025

(54) DEVICE, METHOD AND PROGRAM FOR DETECTING TARGET EQUIPMENT

(71) Applicant: Nippon Telegraph and Telephone Corporation, Tokyo (JP)

(72) Inventors: Yusuke SAKURAHARA, Musashino-shi, Tokyo (JP); Yukihiro GOTO, Musashino-shi, Tokyo (JP); Takashi EBINE, Musashino-shi, Tokyo (JP)

(21) Appl. No.: 18/730,846

(22) PCT Filed: Jan. 31, 2022
(86) PCT No.: PCT/JP2022/003488

§ 371 Date: Jul. 22, 2024

(51) Int. Cl. G06T 17/00; G06V 10/60; G06V 10/764

(52) U.S. Cl. CPC G06T 17/00; G06V 10/60; G06V 10/764; G06V 2201/07

(57) ABSTRACT

Provided is a device and a method for extracting point clouds of structures from point clouds by clustering a point cloud in which each point represents three-dimensional coordinates, and detecting a target facility from the structures using reflection intensities of the extracted point clouds of the structures.

### TECHNICAL FIELD

The present disclosure relates to a technique for detecting a target facility from three-dimensional point cloud data.

### BACKGROUND ART

A technique for three-dimensionally modeling a structure disposed outdoors by a mobile mapping system (MMS) equipped with a three-dimensional laser scanner has been developed (refer to Patent Literature 1, for example). The technique involves creating a point cloud and a scan line in a space where no point cloud is present, and creating a three-dimensional model using the created point cloud and scan line.

It is desired to be able to three-dimensionally model only a target facility for which facility information needs to be calculated. However, existing devices only have a function of determining whether the model coordinates of a three-dimensional model are close to coordinates in facility information provided in advance. On the other hand, when a utility pole is a target facility, for example, a wide range of three-dimensional models are created such as utility poles, trees, and street lamps. Therefore, currently, it is necessary to determine which three-dimensional model is a pole model of a utility

### CITATION LIST

### Patent Literature

Patent Literature 1: JP 2017-156179 A

### SUMMARY OF INVENTION

### Technical Problem

An object of the present disclosure is to enable automatic detection of a target facility from three-dimensional point cloud data.

### Solution to Problem

A three-dimensional laser scanner can measure not only a reflection position of laser light but also the reflection intensity of the laser light. Therefore, in the present disclosure, it is possible to automatically determine a target facility using the reflection intensity of a three-dimensional point cloud.

Specifically, a device and method of the present disclosure include:
extracting point clouds of structures from point clouds by clustering a point cloud in which each point represents three-dimensional coordinates; and
detecting a target facility from the structures using reflection intensities of the extracted point clouds of the structures.

Specifically, a program of the present disclosure is a program for causing a computer to be realized as a functional unit included in the device according to the present disclosure and is a program for causing a computer to execute each step included in the method executed by the device according to the present disclosure.

### Advantageous Effects of Invention

According to the present disclosure, it is possible to automatically detect a target facility from three-dimensional point cloud data.

### BRIEF DESCRIPTION OF DRAWINGS

FIG. 1 illustrates an example of point cloud data.

FIG. 2 illustrates an example of a three-dimensional model in which a structure is objectified.

FIG. 3 illustrates an example of a reflection intensity of a point cloud reflected by a utility pole.

FIG. 4 illustrates an example of a reflection intensity of a point cloud reflected by a tree.

FIG. 5 illustrates an example of a system configuration according to an embodiment of the present disclosure.

FIG. 6 illustrates an example of a block configuration of the present embodiment.

FIG. 7 illustrates an overview of processing executed by an extraction processing unit.

FIG. 8 illustrates an example of a flowchart of processing executed by the extraction processing unit.

FIG. 9 illustrates an example of a flowchart of processing executed by the extraction processing unit.

FIG. 10 illustrates an example of the ratio of the numbers with differences of reflection intensity exceeding 2000 from points on adjacent scan lines.

### DESCRIPTION OF EMBODIMENTS

Hereinafter, embodiments of the present disclosure will be described in detail with reference to the drawings. Note that the present disclosure is not limited to the following embodiments. These examples are merely examples, and the present disclosure can be implemented in a form with various modifications and improvements based on the knowledge of those skilled in the art. Note that components having the same reference numerals in the present specification and the drawings indicate the same components.

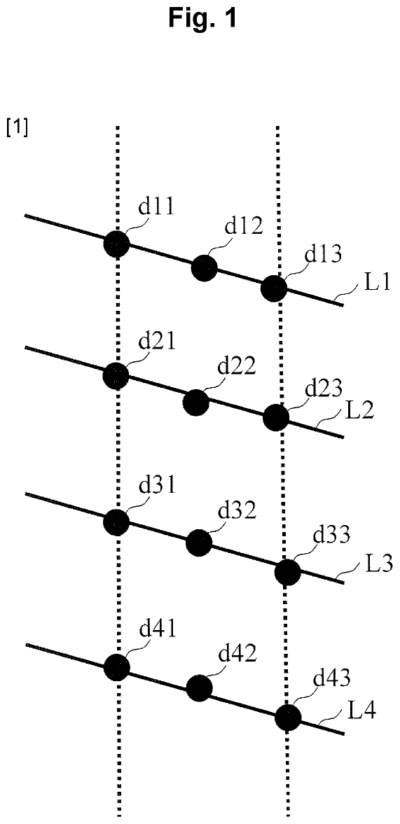

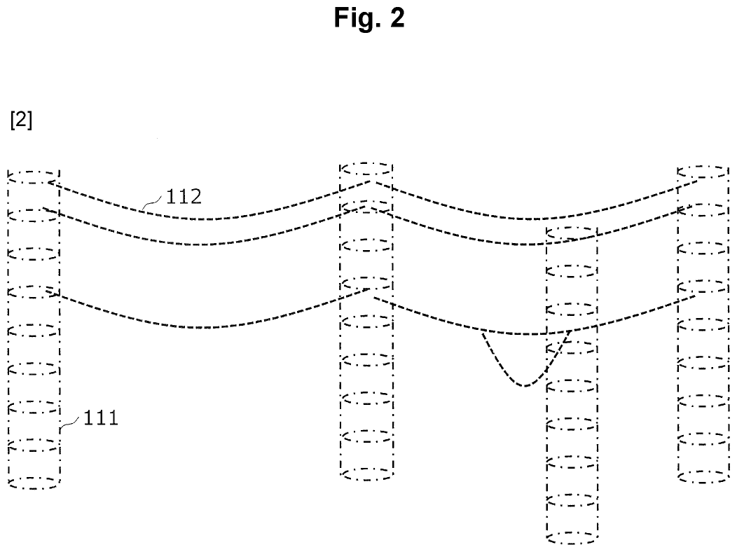

The present disclosure is a device and a method for selectively creating a three-dimensional model of a target facility from point cloud data representing three-dimensional coordinates acquired by a three-dimensional laser scanner. FIG. 1 illustrates an example of point cloud data. Point cloud data is data representing a surface shape of a structure as a set of points, and each point represents three-dimensional coordinates of the surface of the structure. In the point cloud data of the present disclosure, a reflection intensity of laser light reflected by the surface of the structure is included in each point. By forming L1 to L4 connecting points of the three-dimensional point cloud data, it is possible to create a three-dimensional model in which the structure is objectified. For example, as illustrated in FIG. 2, a three-dimensional utility pole model 111 and a three-dimensional cable model 112 can be created.

In the present disclosure, the lines L1 to L4 as illustrated in FIG. 1 are referred to as scan lines. In the present disclosure, a point cloud acquired during one rotation of a three-dimensional laser scanner is treated as one scan line measured at the same time. For example, in a case in which a point cloud constituting the line L1 is measured at a time T1, the scan line L1 is treated as one scan line. Furthermore, the coordinate axis of the three-dimensional coordinates of each point is arbitrary, but for example, a travel direction of an MMS can be x, the depth direction can be y, and the height direction can be z.

### Overview of Present Disclosure

The reflection intensity of light varies depending on the surface shape and material of a substance. Therefore, a common feature appears in light intensities of point clouds reflected by the same substance. Therefore, in the present disclosure, a reflection intensity is verified for each scan line determined to be one cluster, and whether or not the scan lines are the same substance is determined.

Here, a fine surface shape cannot be checked only by coordinates of a reflection point cloud radiated to a substance at a long distance. However, when a point cloud is measured from a relatively short distance, as the angle between a three-dimensional laser scanner and a measurement point (an incident angle/reflection angle of laser radiation) decreases, the reflection intensity increases in the case of the same substance. For this reason, the reflection intensity of a point cloud colliding with a cylindrical structure (a utility pole, a cable, or the like) made of a constant material increases when the point cloud collides with the central portion of the cylindrical object and decreases when the point cloud collides with the edge portion.

For example, in a case in which the scan line L1 illustrated in FIG. 1 is measured at the time T1, the scan line L2 is measured at a time T2, and then the scan line L3 is measured at a time T3, it is possible to theoretically check regular changes in the scan lines L1 to L3 in the case of a cylindrical structure (a utility pole, a cable, or the like) made of a constant material when checking from a point cloud with an early acquisition time. On the other hand, a natural object such as a tree often has a surface shape that is not smooth even when the material is constant, and a regular change in reflection intensity is not observed. Therefore, it is possible to discriminate between an artificial object such as a utility pole or a cable and a natural object on the basis of the reflection intensity of a point cloud.

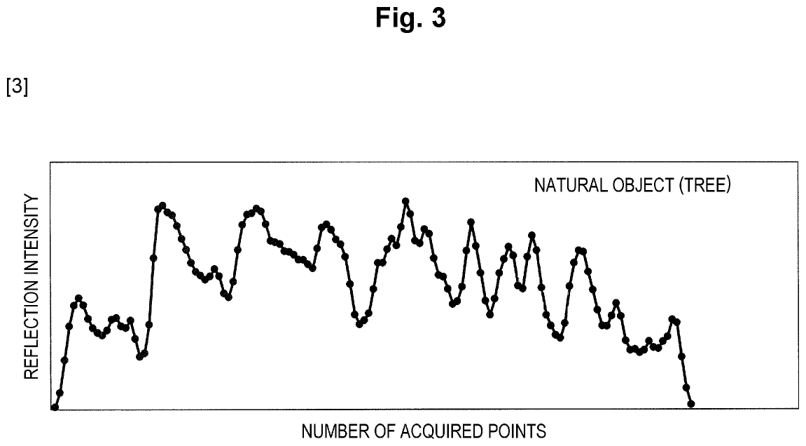

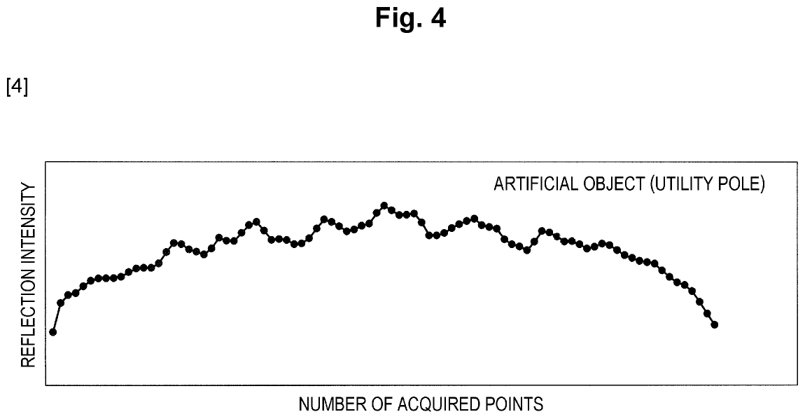

FIGS. 3 and 4 illustrate examples of reflection intensities of point clouds actually measured using a three-dimensional laser scanner. In the case of a tree, as illustrated in FIG. 3, irregularities are severe. On the other hand, in the case of a utility pole, as illustrated in FIG. 4, a curved shape appears although there are some irregularities.

Therefore, in the present disclosure, a difference in surface shape between an artificial object and a natural object made of the same material is determined from changes in reflection intensities of three-dimensional point cloud data. Accordingly, the present disclosure can more accurately determine whether or not a facility is a target facility.

Specifically, a device according to the present embodiment executes the following processing.
Clustering is performed from three-dimensional coordinates or the like of point clouds by density-based spatial clustering of applications with noise (DBSCAN) or the like, and scan lines are extracted.
A cylindrical object is searched for among the shapes of the scan lines.
Scan lines used for the same cylindrical object are extracted from three-dimensional coordinates of point
Changes in the reflection intensities of the scan lines regarded as the same cylindrical object are checked. If the changes in the reflection intensities of the scan lines are within a threshold value, they are determined as an artificial object, and if the changes have randomness, they are determined as a natural object.

Here, scan lines of a cylindrical object are unique. For example, in the case of a cylindrical object, as illustrated in FIG. 1, a plurality of scan lines having a curvature as compared with a flat scan line and having a short length similar to the flat scan line are aligned in parallel. In addition, points d11, d21, d31, and d41 are aligned, and points d13, d23, d33, and d43 are linearly aligned at positions corresponding to the edges of the cylindrical object. Therefore, the cylindrical object is searched for on the basis of the features of these scan lines.

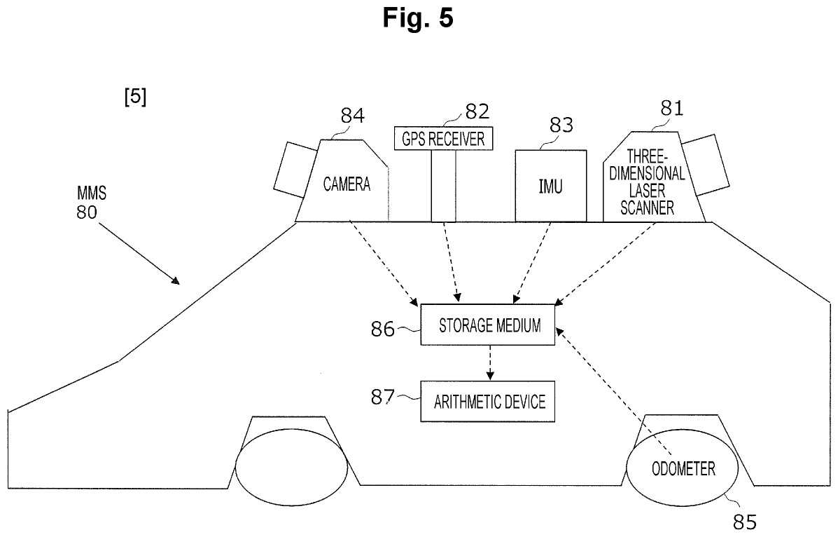

FIG. 5 illustrates an example of a system configuration according to an embodiment of the present disclosure. A system according to the present embodiment is an MMS 80 including a three-dimensional laser scanner 81, a GPS receiver 82, an inertial measurement unit (IMU) 83, a camera 84, an odometer 85, a storage medium 86, and an arithmetic device 87. The MMS 80 divides data acquired by various measuring instruments (IMU 83, three-dimensional laser scanner 81, camera 84, odometer 85, and GPS receiver 82) into point cloud data and image data and stores the data in the storage medium 86.

The three-dimensional laser scanner 81 measures point cloud data of a structure.

The GPS receiver 82 measures the geographic location of the MMS 80.

The camera 84 captures a photograph of a structure measured by the three-dimensional laser scanner 81.

The odometer 85 measures a travel distance of the MMS 80.

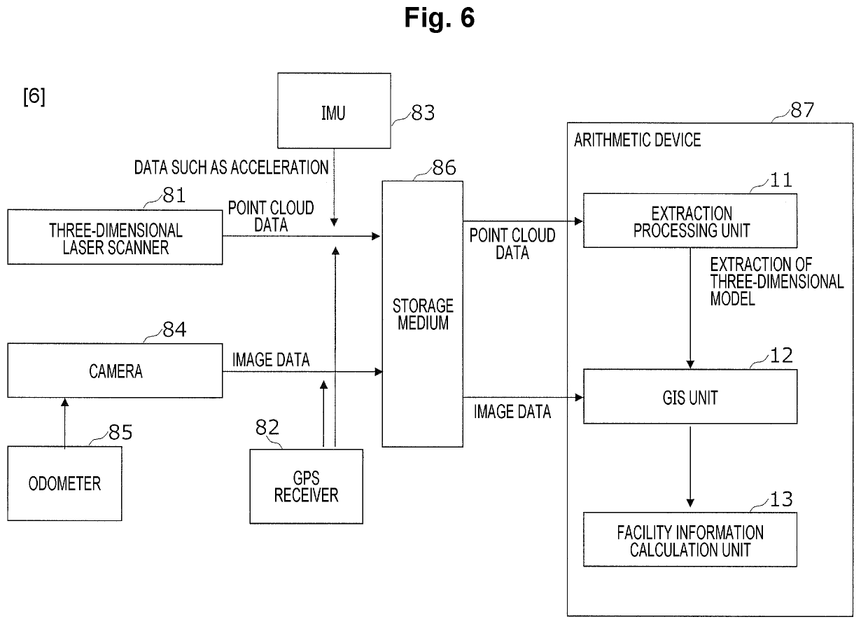

FIG. 6 illustrates an example of a block configuration of the present embodiment. The arithmetic device 87 serves as a device of the present disclosure and includes an extraction processing unit 11, a geographic information system (GIS) unit 12, and a facility information calculation unit 13. The arithmetic device 87 can also be realized by a computer and a program, and the program can be recorded in a recording medium or provided through a network.

The extraction processing unit 11 generates a three-dimensional model of a target facility from point cloud data stored in the storage medium 86.

The GIS unit 12 acquires geospatial information on the basis of image data stored in the storage medium 86. As a result, point clouds of the structure extracted by the extraction processing unit 11 are associated with the geospatial information.

The facility information calculation unit 13 calculates facility information on the basis of the three-dimensional model of the structure and the geospatial information. The facility information is, for example, deflection of a utility pole, cable looseness, and the like.

In the present disclosure, before creating the three-dimensional model, the extraction processing unit 11 performs clustering of point clouds and checks reflection intensities of a clustered point cloud to determine whether the point cloud is an artificial object or a natural object, thereby detecting the target facility.

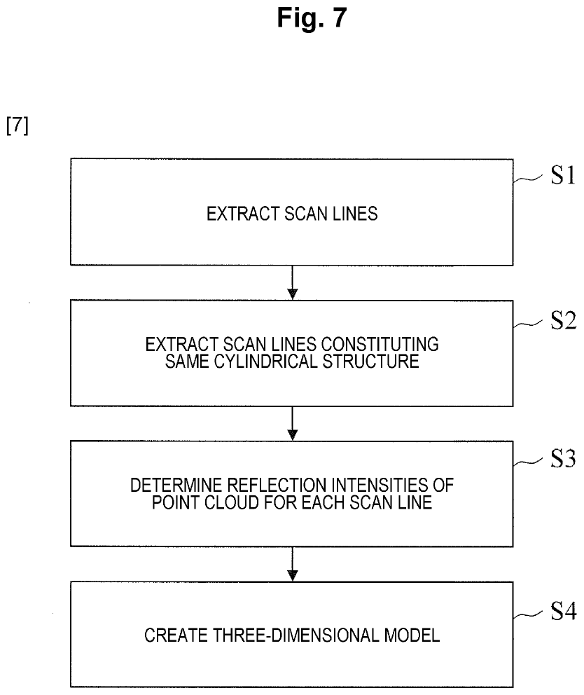

FIG. 7 illustrates an overview of processing executed by the extraction processing unit 11.
Step S1: The extraction processing unit 11 extracts scan lines as candidates constituting a cylindrical object from point clouds. Here, DBSCAN is a clustering technique and is a technique of regarding a point cloud included in a condition in which there are a certain number or more of points within a threshold distance of a certain point, as one mass and clustering the point cloud.
Step S2: The extraction processing unit 11 extracts scan lines constituting the same cylindrical
Step S3: The extraction processing unit 11 determines whether reflection intensities of point clouds constituting the extracted scan lines regularly change.

Step S4: The cylindrical object is determined to be an artificial object in the case of regular changes and determined to be an natural object in the case of irregular changes. Therefore, the extraction processing unit 11 creates a three-dimensional model using point clouds constituting the scan lines of the artificial object.

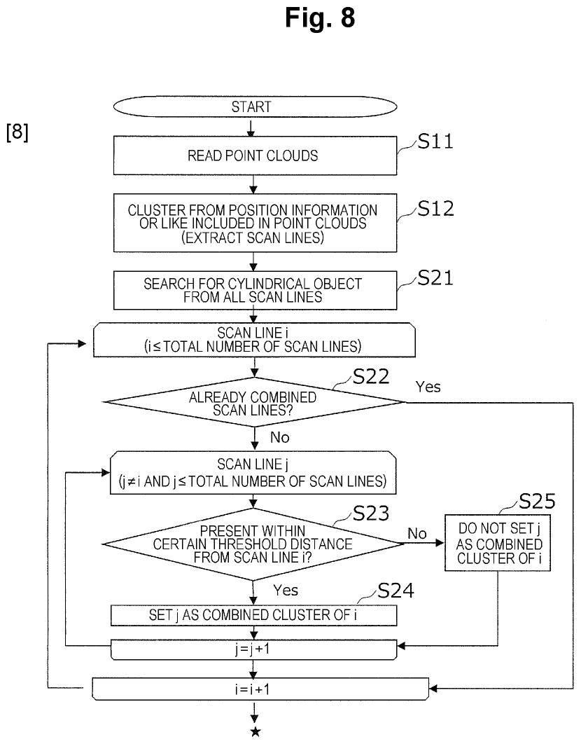

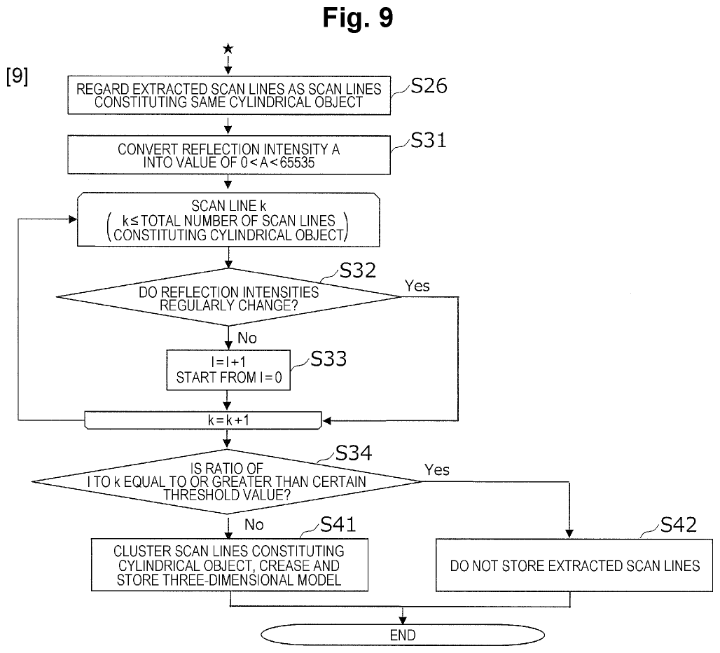

FIGS. 8 and 9 illustrate an example of a flowchart of processing executed by the extraction processing unit 11.

The extraction processing unit 11 reads point clouds (S11), clusters the point clouds from three-dimensional coordinates or the like thereof, and extracts scan lines (S12).

The extraction processing unit 11 searches for a cylindrical object from the extracted scan lines (S21).

The extraction processing unit 11 narrows down scan lines that are candidates for the cylindrical object to scan lines constituting the same cylindrical object and clusters the scan lines (S22 to S25). At this time, a reference scan line is selected from all the candidate scan lines. If there are scan lines within a certain threshold distance from the reference scan line (Yes in S23), the scan lines are regarded as scan lines constituting the same cylindrical object (S26).

The extraction processing unit 11 checks reflection intensities of the scan lines regarded as scan lines constituting the same cylindrical object one by one (S31 to S34).

For example, the reflection intensity of each point included in each scan line is converted into a predetermined value range (for example, 0 to 66535) (S31).

Subsequently, it is determined whether changes in reflection intensities for each scan line are regular (S32), and the total number I of scan lines having irregular reflection intensity changes (S33).

Subsequently, a ratio of the total number I of scan lines having irregular reflection intensity changes to the total number k of scan lines constituting the same cylindrical object is calculated (S34).

If the ratio of the total number I is within a certain threshold value (No in step S34), the cylindrical object is regarded as an artificial object, and a three-dimensional model of the cylindrical object is created (S41).

On the other hand, if the ratio of the total number I is equal to or greater than the certain threshold (Yes in step S34), the cylindrical object is regarded as a natural object, and a three-dimensional model is not created (S42).

Here, display of a reflection intensity varies depending on the model of the three-dimensional laser scanner 81. Therefore, in step S31, the extraction processing unit 11 normalizes a reflection intensity A measured by the three-dimensional laser scanner 81 in which a reflection intensity is represented by a ratio. For example, a minimum value aₘᵢₙ of the reflection intensity A is set to 0, a maximum value aₘₐₓ of the reflection intensity A is set to 65535, and conversion into 0<A<65535 is performed. Similarly, in the case of the three-dimensional laser scanner 81 in which a reflection intensity is displayed as an absolute value, the extraction processing unit 11 performs conversion such that the minimum value becomes 0 and the maximum value becomes 65535. As a result, even in a case in which a point cloud is measured using three-dimensional laser scanners 81 of different models, the extraction processing unit 11 can detect a desired target facility.

Furthermore, in step S32, a method of comparing reflection intensities is arbitrary, but for example, it is possible to align acquired point clouds from an early acquisition time to a late acquisition time, and determine that the object is made of a uniform material and has a smooth surface if the number of portions where reflection intensities greatly change from adjacent points is within a certain threshold value. For example, for each i-th point included in one scan line, it is determined that there is a regular change in a case in which a ratio at which a difference b (b=A_{i +1}−Aᵢ) in reflection intensity between adjacent points exceeds 2000 is 15% or less with respect to the number of point clouds constituting the scan line.

In step S34, in a case in which the number I of scan lines having irregular reflection intensity is 20% or less of the total number k of scan lines constituting the same cylindrical object, for example, the object is regarded as an artificial object (No in S34), and a three-dimensional model is created (S41). On the other hand, in the case of ²⁰% or more (Yes in S34), the object is regarded as a natural object and a three-dimensional model is not created (S42).

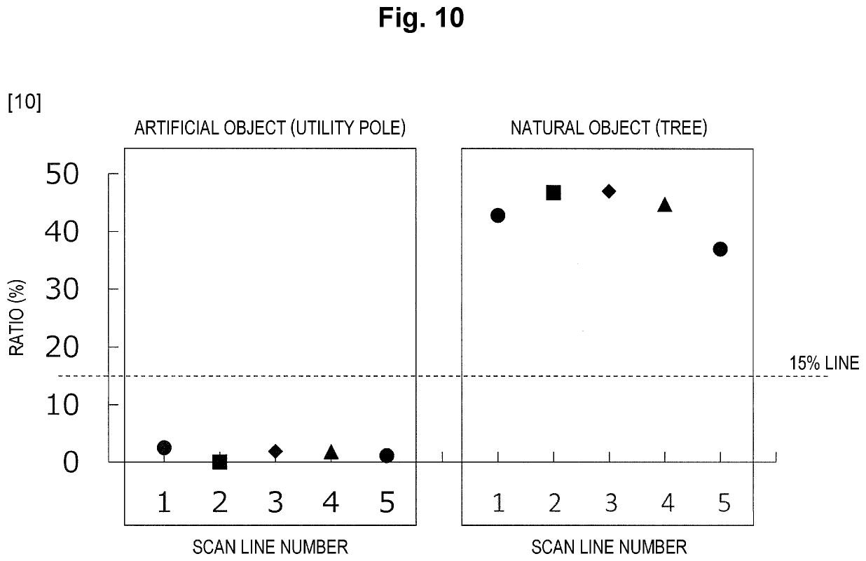

Note that the threshold values in steps S32 and S34 are obtained by extracting 5 scan lines of each of an artificial object (utility pole) and a natural object (tree) as illustrated in FIG. 10 and calculating a ratio of the number of differences b in reflection intensity exceeding 2000, and are not limited to these numerical values.

Further, whether reflection intensities regularly change in step S32 may be determined on the basis of the magnitude of a standard deviation or the absolute value of a difference from an adjacent point. Alternatively, instead of step S33, the total number of scan lines having regular reflection intensity changes may be counted. In this case, Yes and No in the determination in step S32 are reversed.

In addition, although the number of scan lines checked in step S32 may be all, it may be randomly extracted. In this case, instead of step S34, the ratio is a ratio to the number of randomly extracted scan lines. Even in the case of a utility pole, there is a portion where reflection intensities do not change regularly due to the influence of an attachment such as a band, and thus it is desirable to check several scan lines and set the ratio of scan lines having regular reflection intensity changes to the number of extracted scan lines to a threshold value.

### Comparison of Reflection Intensities in Step S23

The determination in step S23 can be performed according to the shape of the cluster formed in step S12.

For example, in the case of an object that is long in the height direction, such as a utility pole or a tree, it is determined whether or not scan lines located above or below a reference scan line are scan lines constituting the same cylindrical object.

For example, in FIG. 1, the reference scan line is set as the scan line L1 acquired at the earliest time, and it is determined whether the scan line L2 acquired at the next rotation is within a threshold distance. In a case in which the point cloud coordinates (x₂, y₂, z₂) constituting the scan line L2 are present within a threshold distance of the point cloud coordinates (x₁, y₁, z₁) constituting the scan line L1, the threshold value for determination determines the scan line as a scan line constituting the same cylindrical object. Here, the threshold distance is determined according to arbitrary conditions such as a traveling speed of the MMS 80 and a structure, and for example, Δx<50 mm, Δy<50 mm, and Δz<200 mm can be exemplified.

For example, in the case of an object that is long in a direction parallel to the ground, such as a cable, it is determined whether a scan line beside a reference scan line is a scan line constituting the same cylindrical object. Threshold distances in this case can be exemplified as Δx<100 mm, Δy<100 mm, and Δz<50 mm.

Depending on a structure and the surrounding environment, there may be a cylindrical object in which the middle of the structure is blocked and only scan lines at the ends such as the upper part and the lower part are extracted. Therefore, in step S23, the columnar body of the finally created cluster may be extended along the central axis of the columnar body, and clusters constituting the same cylindrical object may be extracted. In estimation of the central axis, for example, the central axis of the cylindrical object can be estimated by estimating a circle on a horizontal plane at an arbitrary height in a point cloud used for an extracted scan line and extracting a continuous model (cylindrical object) of the circle by repeating the estimation in the vertical direction.

### INDUSTRIAL APPLICABILITY

The present disclosure can be applied to the information communication industry.

### REFERENCE SIGNS LIST

11 Extraction processing unit
12 GIS unit
13 Facility information calculation unit
81 Three-dimensional laser scanner
82 GPS receiver
83 IMU
84 Camera
85 Odometer
86 Storage medium
87 Arithmetic device

1. A device comprising one or more processors configured to execute instructions that cause the device to perform operations comprising:
extracting point clouds of structures from point clouds by clustering a point cloud in which each point represents three-dimensional coordinates; and
detecting a target facility from the structures using reflection intensities of the extracted point clouds of the structures.

2. The device according to claim 1, wherein the target facility is detected from the structures by determining an artificial structure on the basis of the reflection intensities of the extracted point clouds of the structures.

3. The device according to claim 2, wherein the operations further comprise:
comparing the reflection intensities of the extracted point clouds of the structures between point clouds disposed on the same scan line; and
in a case in which reflection intensities of the point clouds disposed on the same scan line have a predetermined rule, determining the point clouds to be an artificial structure.

4. The device according to claim 3, wherein the operations further comprise: for each point included in a scan line, calculating a difference or a ratio of reflection intensity between adjacent points; and in a case in which a difference or a ratio of reflection intensity between adjacent points on the same scan line is within a certain value, determining the scan line to be an artificial structure.

5. The device according to claim 3, wherein the same scan line is a scan line including a simultaneously measured point cloud.

6. The device according to claim 1, wherein a three-dimensional model of the target facility is created using a point cloud of a structure corresponding to the target facility when the target facility is detected.

7. A method, using a device, comprising:
extracting point clouds of structures from point clouds by clustering a point cloud in which each point represents three-dimensional coordinates; and
detecting a target facility from the structures using reflection intensities of the extracted point clouds of the structures.

8. (canceled)

9. A non-transitory computer-readable medium storing program instructions that, when executed, cause a device to perform operations comprising:
extracting point clouds of structures from point clouds by clustering a point cloud in which each point represents three-dimensional coordinates; and
detecting a target facility from the structures using reflection intensities of the extracted point clouds of the structures.
